(19) United States
(12) Patent Application Publication
(10) Pub. No.: US 2002/0103913 A1
(43) Pub. Date: Aug. 1, 2002

(54) System and method for host based target device masking based on unique hardware addresses

(76) Inventors: Ahmad Tawil, Round Rock, TX (US); Jacob Cherian, Austin, TX (US)

Correspondence Address: Khannan Suntharam, Baker Botts L.L.P., One Shell Plaza, 910 Louisiana Street, Houston, TX, 77002-4995, US

(21) Appl. No.: 09/770,571

(22) Filed: Jan. 26, 2001

(51) Int. Cl. G06F 15/16; G06F 7/00

(52) U.S. Cl. 709/229; 709/245; 707/10; 710/36

(57) ABSTRACT

The system and method is described herein for preventing HBA port logins to a networked target device unless the HBA has been authorized to perform a port login to that networked device. The HBA driver selectively performs a port login with a target device based on whether the unique hardware address of the target device is included on the HBA driver's unique hardware address access table. During the storage assignment step of the login process, the user selects the target devices that will be assigned to the host. The unique hardware addresses of these target devices will be stored on a unique hardware address access list. During the device discovery step of the login process, the HBA driver compares the unique hardware address of the target device with the unique hardware address access list. If the target device's unique hardware address is listed on the unique hardware address access list, then the HBA driver will proceed with a port login with that target device. If the target device's unique hardware address is not present on the unique hardware address access list, then the HBA driver will forego a port login with that target device.

### TECHNICAL FIELD

The present disclosure relates in general to the field of computer networks and, more particularly, to a system and method for masking devices in a network environment.

### BACKGROUND

Computer networking environments such as Local Area Networks (LANs) and Wide Area Networks (WANs) permit many users, often at remote locations, to share communication, data, and resources. This combination of a LAN or WAN with a SAN may be referred to as a shared storage network. A SAN may be used to provide centralized data sharing, data backup, and storage management in these networked computer environments. A storage area network is a high-speed subnetwork of shared storage devices. A storage device is any device that principally contains a single disk or multiple disks for storing data for a computer system or computer network. The collection of storage devices is sometimes referred to as a storage pool. The storage devices in a SAN can be collocated, which allows for easier maintenance and easier expandability of the storage pool. The network architecture of most SANs is such that all of the storage devices in the storage pool are available to all the servers on the LAN or WAN that is coupled to the SAN. Additional storage devices can be easily added to the storage pool, and these new storage devices will also be accessible from any server in the larger network.

In a computer network that includes a SAN, the server can act as a pathway or transfer agent between the end user and the stored data. Because much of the stored data of the computer network resides in the SAN, rather than in the servers of the network, the processing power of the servers can be used for applications. Network servers can access a SAN using the Fibre Channel protocol, taking advantage of the ability of a Fibre Channel fabric to serve as a common physical layer for the transport of multiple upper layer protocols, such as SCSI, TCP/IP, and HiPPI, among other examples. As a result, Fibre Channel technology allows data and network protocols to exist on the same physical media. A SAN is created by a system of interconnected host bus adapters (HBAs), Fibre Channel bridges, storage devices and Fibre Channel switches. A Fibre Channel fabric is created by a system of interconnected Fibre Channel switches. A SAN may contain multiple fabrics for redundancy and improve fault tolerance. A Fibre Channel bridge allows SCSI devices to be connected to the Fibre Channel fabric. A Fibre Channel switch handles multiple connections between storage devices and servers. A HBA is a PCI adapter card that resides in a server and functions to convert data commands from a PCI-bus format to a storage interconnect format, such as SCSI or Fibre Channel, and communicate directly with disk drives, tape drives, CDROMs, or other storage devices. A HBA controller is a PCI adapter card that performs the same function as a HBA but also has a RAID functionality when communicating with multiple disk drives.

In Fibre Channel networks, each device connected to the network is called a node. A node may be a computer, storage device, storage subsystem or any other addressable entity connected to an I/O bus or network. The component of a node that connects the device to the network or bus is called a port. In a network running SCSI protocol, a node can be either an initiator, such as a workstation or server, or a target, such as a data storage device. In a network that is running a protocol other than SCSI, the nodes are designated as originators and responders, respectively. Fibre Channel supports several network topologies, including point-to-point, switched fabric, arbitrated loop, and combinations thereof.

The storage devices in a SAN may be structured in a RAID configuration. When a system administrator configures a shared data storage pool into a SAN, each storage device may be grouped together into one or more RAID volumes and each volume is assigned a SCSI logical unit number (LUN) address. If the storage devices are not grouped into RAID volumes, each storage device will typically be assigned its own LUN. The system administrator or the operating system for the network will assign a volume or storage device and its corresponding LUN to each server of the computer network. Each server will then have, from a memory management standpoint, logical ownership of a particular LUN and will store the data generated from that server in the volume or storage device corresponding to the LUN owned by the server.

When a server is initialized, the operating system assigns all visible storage devices to the server. For example, if a particular server detects several LUNs upon initialization, the operating system of that server will assume that each LUN is available for use by the server. Thus, if multiple servers are attached to a shared data storage pool, each server can detect each LUN on the entire shared storage pool and will assume that it owns for storage purposes each LUN and the associated volume or storage device. Each server can then store the user data associated with that server in any volume or storage device in the shared data storage pool. Difficulties occur, however, when two or more servers attempt to write to the same LUN at the same time. If two or more servers access the same LUN at the same time, the data stored in the volume or storage device associated with that LUN will be corrupted. The disk drivers and file system drivers of each server write a data storage signature on the storage device accessed by the server to record information about how data is stored on the storage system. A server must be able to read this signature in order to access the previously written data on the storage device. If multiple servers attempt to write signatures to the same storage device, the data storage signatures will conflict with each other. As a result, none of the servers will be able to access the data stored in the storage device because the storage device no longer has a valid data storage signature. The data on the storage device is now corrupted and unusable.

To avoid the problem of data corruption that results from access conflicts, conventional storage consolidation software employs LUN masking software. LUN masking software runs on each server and masks the LUNs in order to prevent the operating system from automatically assigning the LUNs. In effect, LLN masking software masks or hides a device from a server. The system administrator may then use the storage consolidation software to assign LUNs to each server as needed. Because a server can access only those devices that it sees on the network, no access conflicts can arise if each LUN is masked to all but one server. In addition to the risk of data corruption, the inherent limitations of a storage device in terms of storage capacity and performance bottlenecks are other reasons for preventing all hosts from having access to the same storage device.

Deployment of large SANs are currently restricted due to the fact that storage devices have limited resources for supporting a large number of hosts on the same SAN. For example, one of the limitations of a storage device is the number of HBAs that can perform port logins per target port on the storage device. FIG. 1 is a flow chart of a conventional HBA port login process at device discovery time. Initially, at step 10, the HBA driver queries the Fabric for available target devices, such as storage devices, from the Name Server in the Fabric. Each host in a switched non-zoned SAN sees the same storage device on each of its HBAs. Fabric protocol requires each HBA initiator to issue a port login (PLOGI) to each storage device at initialization time before any I/Os can occur between the HBA and the storage device. Thus, each HBA will issue a port login to each storage device it sees on the SAN. Because each HBA can see every device on the switched non-zoned SAN, each HBA will issue a port login to every storage device. Accordingly, at step 12, each HBA driver performs a port login with every target device in the Name Server. Next, at step 14, the upper driver, such as the SCSI driver, discovers all target devices with which the HBA driver logged-in. The HBA driver communicates to the upper driver all the devices it sees on the SAN. Afterward, the server continues with other boot-time procedures, such as LUN masking.

Because a storage device can only support a limited number of port logins, the port login process reduces the number of hosts that a SAN can support. For example, when a storage device can handle up to thirty-two maximum port logins, then the number of HBAs connected on the SAN cannot exceed thirty-two. Accordingly, no more than thirty-two hosts with single HBAs, or sixteen hosts with dual HBAs can be connected to the same SAN. The SAN environment 16 shown in FIG. 2 comprises four hosts 18, each with dual HBAs 20, connected to Fabric 22 consisting of switches 24. Two storage devices 26, with dual redundant controllers 26 are also coupled to the Fabric 22. In this example, each storage device 26 has a total of eight HBAs logged in with the storage device 26. This SAN environment 16 cannot fully support any additional hosts 18 if the storage devices 26 can only handle a maximum of eight port logins. For instance, if one of the storage devices 26a supported only four HBAs, then only half of the hosts 18 would be able to see that storage device 26a. Depending on the implementation of the storage device 26a, the rest of the servers 18 will either not see the storage device 26a or they will cause the servers 18 that are already logged in to the storage device 26a to be logged out by the storage device 26a.

A solution to conserve the port login resources of a storage device cannot be based on LLN masking, because the LUN masking process occurs after the HBA port login process. Currently, system administrators may attempt alleviate this problem by arranging the devices connected to the fabric into one or more logical groups called zones. Switch zoning may be based on World Wide Names or physical ports. Devices in the same zone can see each other but devices in different zones cannot see each other. Zones help to partition the SAN by establishing barriers between different operating system environments and creating logical fabric subsets. This type of zoning enables resource partitioning for the purpose of access control. By partitioning a SAN into zones, logical boundaries are created within the Fabric, wherein each zone contains selected devices, including servers and storage devices. The switch firmware grants access to devices within a particular zone only to members of that zone. Devices not included within a particular zone are not available to members of that zone. As a result, zoning effectively divides the SAN into several separate networks, and thereby defeats the purpose of creating a large interconnected network of devices that may be shared. Furthermore, current zoning implementation is vendor specific. As a result, a system administrator must use the same vendor across the network in order to implement zoning. The system administrator therefore loses the ability to chose network components from different vendors.

### SUMMARY

In accordance with teachings of the present disclosure, a system and method for host based device masking based on unique hardware addresses in a network environment are disclosed that provide significant advantages over prior developed systems.

The system and method described herein provides for a management application to configure a HBA driver to perform a port login with a target device based on whether the unique hardware address of the target device is included on the HBA driver's unique hardware address access table. During the storage assignment step of the login process, the user selects the target devices that will be assigned to the host. The unique hardware address of these target devices will be stored on a unique hardware address access table. During the device discovery step of the login process, the HBA driver compares the unique hardware address of the target device with a unique hardware address access table. If the target device's unique hardware address is listed on the unique hardware address access table, then the HBA driver will proceed with a port login with that target device. If the target device's unique hardware address is not present on the unique hardware address access table, then the HBA driver will forego a port login with that target device. As a result, the HBA driver will not perform a port login with a target device unless that device has been assigned to the host.

The disclosed system and method provide several technical advantages over conventional approaches to the HBA port login process in a network environment. One advantage provided by the disclosed system and method is that the HBA driver performs a port login with a selected number of target devices, rather than all of the target devices on the network. As a result, unnecessary HBA port logins to the target devices are substantially eliminated. Accordingly, the number of hosts that may be added to the computer network is not limited by the number of port logins that a given target device can handle. The disclosed system and method is also advantageous in that it does not divide the network into zones. Other technical advantages should be apparent to one of ordinary skill in the art in view of the specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a flow chart of a conventional HBA port login process at device discovery time;

FIG. 2 is a diagram illustrating a storage area network;

FIG. 3 is a diagram illustrating one embodiment of the present invention;

FIG. 4 is a flow chart illustrating one embodiment of the HBA port login process during storage assignment of the present invention; and

FIG. 5 is a flow chart illustrating one embodiment of the HBA port login process during device discovery of the present invention.

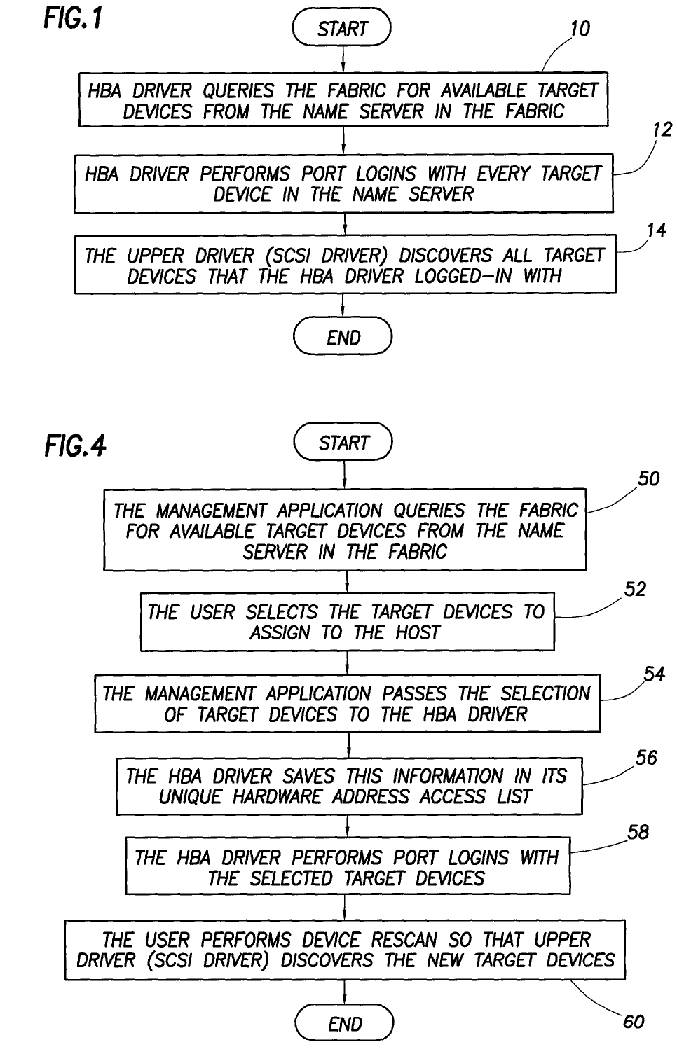

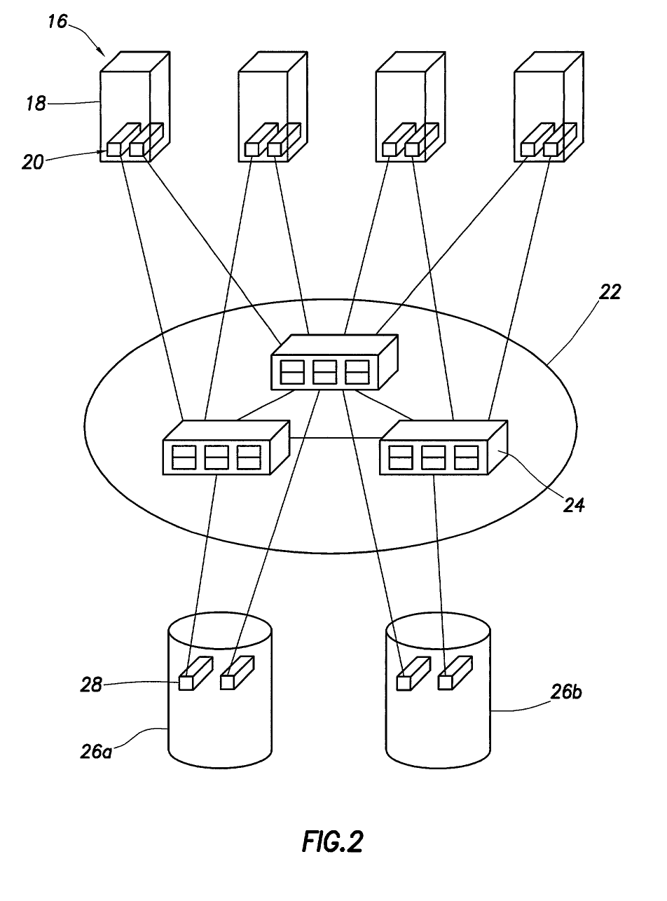

### DETAILED DESCRIPTION

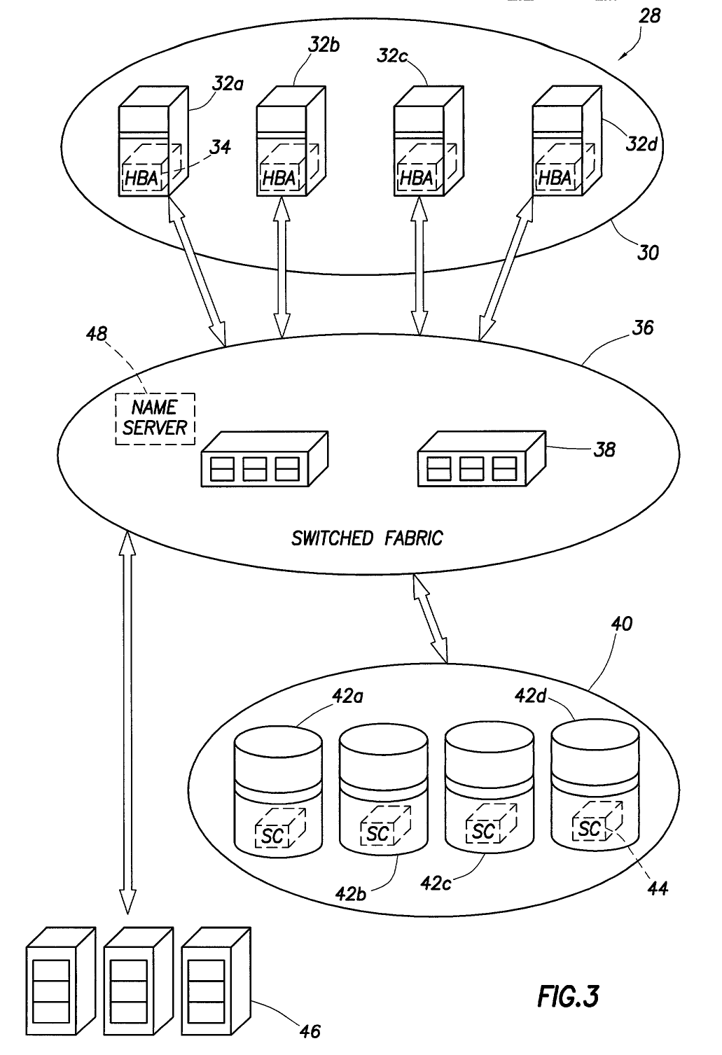

FIG. 3 is a diagram of a storage area network (SAN), indicated generally at 28. Computer network 28 includes a server network 30. Server network 30 comprises a plurality of hosts or servers 32, which can include UNIX-based servers, WINDOWS NT-based servers, NETWARE servers, thin server computers, and other server or computer systems. Server network 30 may be, for example, a local area network (LAN), a wide area network (WAN), or other network allowing transmission of data between computing devices. Hosts 32 may employ a variety of network protocols for the transfer of data, including TCP/IP. The number of hosts 32 may vary from the number shown in FIG. 3 and described in this disclosure. Each host 32 is communicatively coupled to a host bus adapter (HBA) 34. HBA 34 may be a PCI adapter card that resides in host 32 and is operable to convert data commands from a PCI-bus format to a storage interconnect format, such as SCSI or Fibre Channel for example, and thereby communicate directly with storage devices such as disk drives, tape drives and CD-ROMs. HBA 34 may also be a host-based RAID controller. A host-based RAID controller is a PCI adapter card that has the same function as an HBA, but is also operable to perform a RAID functionality when communicating with multiple disk drives. HBA 34 may be a dual HBA to provide redundant functionality. Hosts 32 are loaded with HBA drivers. The HBA driver allows the host 32 to use the HBA card 34 and connect to SAN network 28. The HBA 34 provides an interface between the PCI bus of the server and the storage devices of the SAN 28.

SAN 28 further includes a fabric or switching fabric 36. Fabric 36 may be a high speed network interconnect or high speed optical network interconnect. For example, fabric 36 may be a Fibre Channel fabric. The SAN 28 is created by a set of interconnected HBAs 34, bridges, network devices and switches. The fabric 36 is composed of several switches 38 that allow various electronic interconnections between the various devices that compose computer network 28. For example, in a Fibre Channel fabric, switches 38 will be Fibre Channel switches. Storage subsystem 40 comprises a plurality of physical storage devices 42. Storage devices 42 may be any devices suitable for storing data, such as a collection of hard disk drives or other integrated non-volatile memory. The storage devices may be SCSI devices, or Fibre Channel devices, for example. Each storage device is coupled to a storage controller 44. Storage controller 44 is a device suitable for coordinating access to storage devices 42. Storage controller 44 may be a RAID (Redundant Array of Independent Disks) controller whereby storage devices 42 can be grouped into RAID volumes. Each storage device 42 or RAID volume may be assigned a logical unit number (LUN) address. Hosts 32 within server network 30 can transfer data between other servers 32 as well as to and from storage subsystem 40. Storage subsystem 40 provides a large amount of storage space and can be operated as the consolidated storage for computer network 28. Storage subsystem 40 can include fewer or more storage devices 42 than depicted in FIG. 3.

Computer network 28 may also include dedicated backup storage devices 46 that are coupled to fabric 36. Dedicated backup storage devices 46 can include, for example, computing devices having removable storage such as a tape medium or any other computer readable medium conventionally used for backup storage. For example, the dedicated backup storage device 28 can include a tape storage device such as a DLT tape library. Dedicated backup storage devices 46 can provide backup services to storage subsystem 40. Computer system 28 also includes a name server 48 that is coupled to the fabric 36. The name server 48 is operable to provide, in response to a name server query, a list of network devices on the fabric 36. For example, the name server 48 may maintain a database of all devices that perform a fabric login to fabric 36. The name server 48 may be a function provided by the fabric switches 38.

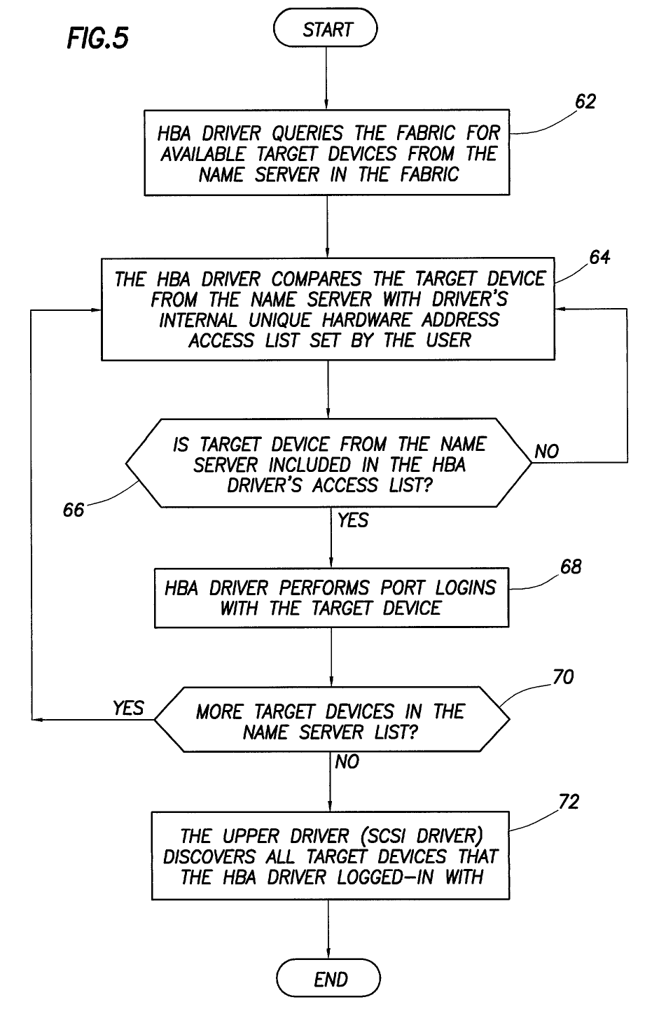

FIG. 4 shows the HBA port login process during storage assignment. Storage assignment is the process of apportioning storage devices to each host. At step 50, a management application queries the fabric 36 for all available target devices from the name server 48 in the fabric 36. Typically, this occurs after the HBA has performed a fabric login. The management application is any software agent that allows the user to manage target device allocation to the hosts. For example, the management application allows the user to allocate storage devices to the hosts. The management application communicates between the end user and the HBA driver to allow the user to allocate the target devices. The management application can be centralized or distributed. The management application may include, for example, storage consolidation software that allows storage to be shared or apportioned among servers, implement LUN masking to prevent the operating system from automatically assigning LUNs, and provide other functions to manage a network environment. In response to the management application's query, the name server 48 provides a list of the unique hardware addresses for all the target devices in the fabric 36. As discussed above, name server 48 is a server that maintains a list of all the target devices, such as storage devices 42, in the fabric 36. Name server 48 also maintains a list of all the corresponding unique hardware addresses for the target devices in the fabric 36.

The unique hardware address is a hardware specific label or address that is unique to each node of a network. For example, the unique hardware address may be a port name or a node name. Thus, each storage device 42 has a globally unique hardware address for its network connection. A unique hardware address may be similar to a media access control (MAC) address, an hardware addressing system implemented by the Institute of Electrical and Electronics Engineers, Inc. (IEEE). The unique hardware address may be any globally unique assigned number referenced or maintained according to a standard. For Fibre Channel networks, the unique hardware address is preferably a World Wide Name (WWN). Other types of unique hardware addresses may be used with other types of network protocols. A WWN is a unique number assigned by a recognized naming authority, such as IEEE, that identifies a connection or a set of connections to the network. WWNs are often assigned via a block assignment to a manufacturer of network hardware. A WWN is assigned for the life of a connection (for the device). Most networking technologies, such as Ethernet, FDDI and others, use a worldwide naming convention. The management application can retrieve a list of the target devices on the computer network 28 from the fabric 36 via name server query commands such as get node name (GNN_ID) and get port name (GPN_ID). These commands identify the node name and port name for each target device on the computer network 28. Thus, these commands provide the HBA with the WWN information from the Fabric name server 48 for each target device on the network 28. The name server 48 is able to provide a list of all target devices on the fabric 36, because each device on the network 28, such as an HBA or storage device 42, must perform a fabric login, or FLOGI, with the fabric at initialization time. Each network device provides the WWN information associated with its port during the fabric login process, which is initiated by the network device.

At step 52, the user or system administrator selects the target devices that will be assigned to the hosts 32 from the list of unique hardware addresses provided by the management software. For example, the user may select and assign a storage device 42 to a host 32 for the purposes of data storage allocation. At step 54, the management application passes the selection of target devices that the host 32 may access to the HBA driver associated with the host 32. The HBA driver then stores the unique hardware addresses of the selected target devices on a unique hardware address access list or table associated with the HBA driver in step 56. The unique hardware address access list may be stored in a memory location that may be accessed by the HBA. For example, the unique hardware address access list may be stored in the HBA's memory. The HBA driver then performs port logins with only those target devices whose unique hardware addresses are present on the unique hardware address access list at step 58. Next, the user performs a device rescan so that the upper driver, such as a SCSI driver, may discover the new target devices at step 60. Thus, each HBA on each host 32 is not permitted to perform a port login with a target device at initialization, unless the user or system administrator, through the management application, has configured the host 32 or HBA to do so. The management application allows the user or system administrator to select a target device based on the unique hardware address of the target device and then authorize the HBA to perform a port login with that target device. The user may also de-select target devices from the unique hardware address access list. The management application allows the user to de-select the device and passes this information to the HBA driver. The HBA driver then performs a port log-out of the de-selected device.

FIG. 5 shows the HBA port login process during device discovery. Device discovery is the process of determining what devices are connected to the fabric 36 in order to determine the extent and availability of network resources. At step 62, the HBA driver queries the fabric 36 for available target devices from the name server 48. The name server returns a name server in response to the HBA driver's query. The name server list is a list of the unique hardware addresses of all the target devices connected to the fabric 36. Next, the HBA driver reviews the name server list. At step 64, the HBA driver compares each target device on the name server list to the unique hardware address access table. For each target device on the name server list, the HBA driver determines whether or not that target device is included on the unique hardware address access table. at step 66. If the, target device is not listed on the unique hardware address access table, then this absence indicates that the host 32 associated with the HBA driver is not entitled to have access to that target device. Accordingly, the HBA driver continues to the next entry on the name server list and compares the next target device to the unique hardware address access table as shown in step 64. However, if the target device listed on the name server list is also on the unique hardware address access list, then this indicates that the host 32 associated with the HBA driver is entitled to have access to that target device. Accordingly, the HBA driver performs a port login with the target device in step 68. If there are more target devices listed on the name server list, then the HBA driver continues to the next target device listed on the name server list to determine whether this target device is also listed on the unique hardware address access list. Thus, the HBA driver repeats steps 64 through 68. If there are no more target devices listed on the name server list, then the HBA driver has made a determination for every target device connected to the fabric 36. After the HBA driver has loaded and completed its comparison of the unique hardware address access list with the name server list, other drivers and software of a higher level functionality are loaded. Other drivers that may be loaded include those drivers necessary for the host 32 to read off its hard disk drive, run the video cards, display signals on the monitor, initialize the start menu, and other basic functions. At step 72, the upper driver, e.g. the SCSI driver, discovers all the target devices with which the HBA driver has logged-in.

Note that the LUN masking driver is a higher level functionality than the HBA driver and therefore loads onto the host after the HBA driver. Because the unique hardware address access list preferably lists only those target devices to which the host 30 should have access, the LUN masking driver will not need to mask any of the target devices listed on the unique hardware address access list. When the operating system initially loads onto the host 30, the operating system will communicate with the disk driver to identify the target devices that are located on the computer network 28. Accordingly, the operating system issues a command to identify all of the available LUNs on the computer network 28. The disk driver will respond with all of the LUN addresses that are not masked. The LUN masking driver effectively prevents the corruption of target devices such as storage devices 42 by masking the existence of the storage devices 42 from the operating system. The operating system will only be able to view, and accordingly access, those LUNs that are not masked.

The presently disclosed system and method alleviates the problem of unnecessary HBA port logins. Because the HBA will only perform a port login with a selected target device, rather than with every target device identified on the fabric 36, the number of port logins that a target device can support does not serve as a limitation to the expansion of the computer network. Managing the HBA port logins does not restrict the flexibility of the computer network 28 because the hosts 32 do not need to have access to every target device on the fabric 36. For example, target devices such as storage devices have inherent limitations in terms of performance bottlenecks and storage capacity that prevent the target device from effectively serving a large number of hosts 32. In fact, it is preferable that each host 32 only have access to only a selected set of storage devices, for example, in order to avoid the risk of data corruption as discussed above.

Although the disclosed embodiments have been described in detail, it should be understood that various changes, substitutions, and alterations can be made to the embodiments without departing from their spirited scope.

What is claimed is:

1. A storage area network comprising:
a high speed network interconnect;
one or more target devices coupled to the high speed network interconnect, wherein each target device has a unique hardware address;
a host, wherein the host comprises a host bus adapter (HBA) operable to perform a port login with a target device; and
a unique hardware address table stored in a memory, wherein the unique hardware address table stores the unique hardware address of every target device that the host is authorized to access such that the HBA will not perform a port login with a target device unless the unique hardware address of that target device is present on the unique hardware address table.

2. The storage area network of claim 1, wherein the unique hardware address is a port name.

3. The storage area network of claim 1, wherein the unique hardware address is a node name.

4. The storage area network of claim 1, wherein the unique hardware address is a World-Wide Name.

5. The storage area network of claim 1, wherein the target device is a storage device.

6. The storage area network of claim 1, wherein the HBA comprises the memory.

7. The storage area network of claim 1, wherein the high speed network interconnect is a high speed optical network interconnect.

8. The storage area network of claim 1, wherein the high speed network interconnect is a Fibre Channel fabric.

9. A method for managing the port login performed by a host bus adapter (HBA) for a host that is communicatively coupled to a fabric, wherein one or more target devices, each having a unique hardware address, are coupled to the fabric; comprising the steps of:
querying the fabric for available target devices;
determining whether the unique hardware address of an available target device is present on a unique hardware address table, wherein the unique hardware address table contains the unique hardware addresses of each target device that the host is authorized to access; and
performing a port login with each target device whose unique hardware address is present on the unique hardware address table.

10. The method of claim 9, wherein the unique hardware address is a port name.

11. The method of claim 9, wherein the unique hardware address is a node name.

12. The method of claim 9, wherein the unique hardware address is a World-Wide Name.

13. The method of claim 9, wherein the target device is a storage device.

14. The method of claim 9, wherein the HBA comprises the memory.

15. The method of claim 9, wherein the fabric is a Fibre Channel fabric.

16. A method for managing the port login performed by a host bus adapter (HBA) for a host that is communicatively coupled to a fabric, wherein one or more target devices, each having a unique hardware address, are coupled to the fabric; comprising the steps of:
querying the fabric for available target devices;
selecting target devices that may be accessed by the host; and
storing the unique hardware address of the selected target devices to a unique hardware address access table, wherein the HBA will not perform a port login with a target device unless the unique hardware address of the target device is present on the unique hardware address table.

17. The method of claim 16, wherein the unique hardware address is a port name.

18. The method of claim 16, wherein the unique hardware address is a node name.

19. The method of claim 16, wherein the unique hardware address is a World Wide Name.

20. The method of claim 16, wherein the target device is a storage device.

21. The method of claim 16, wherein the HBA comprises the memory.

22. The method of claim 16, wherein the fabric is a Fibre Channel fabric.

23. A host bus adapter (HBA) operable to perform a port login comprising:
a memory;
a unique hardware address access table in memory, operable to contain one or more unique hardware addresses corresponding to one or more target devices with which the host bus adapter is authorized to perform a port login.

24. The HBA of claim 23, wherein the unique hardware address is a port name.

25. The HBA of claim 23, wherein the unique hardware address is a node name.

26. The HBA of claim 23, wherein the unique hardware address is a World-Wide Name.

27. The HBA of claim 23, wherein the target device is a storage device.

28. The HBA of claim 23, wherein the HBA comprises the memory.

29. A computer system comprising:
a host bus adapter (HBA) operable to perform a port login comprising:
a memory;
a unique hardware address access table in memory, operable to contain one or more unique hardware addresses corresponding to one or more target devices with which the host bus adapter is authorized to perform a port login.

30. The computer system of claim 29, wherein the unique hardware address is a port name.

31. The computer system of claim 29, wherein the unique hardware address is a node name.

32. The computer system of claim 29, wherein the unique hardware address is a World-Wide Name.

33. The computer system of claim 29, wherein the target device is a storage device.

34. The computer system of claim 29, wherein the HBA comprises the memory.
